(19) United States
(12) Patent Application Publication
(10) Pub. No.: US 2016/0008709 A1
(43) Pub. Date: Jan. 14, 2016

(54) INFRARED GAME CONTROL SYSTEM AND CONTROL METHOD OF THE SAME

(71) Applicant: Yu-Hsi Pai, Taichung City (TW)

(72) Inventor: Yu-Hsi Pai, Taichung City (TW)

(21) Appl. No.: 14/329,987

(22) Filed: Jul. 14, 2014

(51) Int. Cl. A63F 13/213; A63F 13/837; A63F 13/25

(52) U.S. Cl. CPC A63F 13/213; A63F 13/25; A63F 13/837

(57) ABSTRACT

The present invention provides an infrared game control system. The infrared game control system includes an infrared detection module having an infrared transmitter and an infrared receiver, a signal processing module having an aim indicator LED and a hit indicator LED and a power supply module having an electrical switch. The infrared detection module transmits and receives an infrared signal. The aim indicator LED or the hit indicator LED is lighted up based on the infrared signal received by the infrared receiver of the infrared detection module. Moreover, the power supply module provides power to the infrared detection module and the signal processing module. In addition, the present invention further provides an infrared game control method.

### BACKGROUND OF THE INVENTION

1. Field of the Invention

The present invention relates generally to game control systems, and more particularly, to an infrared game control system and a control method thereof.

2. The Prior Arts

Nowadays, due to advances in electronic technology, the electronic game market has been developed dramatically. The forms of electronic game may include arcade games, handheld games, video games, computer games, mobile games and online games.

Generally, an arcade game is an entertainment machine, and usually installed in public businesses. A common arcade game may consist of two parts: a frame and a machine. Most arcade games are pinball machines, electro-mechanical games, merchandiser games, and redemption games.

With regard to the handheld games, a handheld game console is a lightweight, portable electronic device with a built-in screen, speakers and game controls. Regarding the video games, a video game consists of images and sounds generated by a video game console, and displayed on a television. The video game is usually controlled and manipulated using a controller.

Computer games are played on a general-purpose computer, and controlled by a keyboard, a mouse or a joystick. Additionally, mobile games are played on a phone, smartphone, PDA, or tablet computer. Further, online games are played over computer networks, typically on the Internet, and may be played by multiple players.

As such, the foregoing electronic games are played in virtual environments, but may not be played in physical environments. Accordingly, the prior art electronic games may not provide players with diversified interactive games.

Therefore, for the sake of meeting the requirement of providing multiple players with diversified interactive games in physical environments, it is necessary to provide a game control system and a game control method having high security, low cost and high portability.

### SUMMARY OF THE INVENTION

In light of the foregoing drawbacks, an objective of the present invention is to provide an infrared game control system and a method thereof, enabling a user/player to conduct a game activity by means of a carrier such as a remote-controlled airplane, a remote-controlled boat or a remote-controlled vehicle.

For achieving the foregoing objective, the present invention provides an infrared game control system, including an infrared detection module, having an infrared transmitter and an infrared receiver, and transmitting and receiving an infrared signal; a signal processing module, having an aim indicator LED and a hit indicator LED and electrically connected to the infrared detection module, wherein the aim indicator LED or the hit indicator LED is lighted up in accordance with the infrared signal received by the infrared receiver of the infrared detection module; and a power supply module, having an electrical switch and electrically connected to the infrared detection module and the signal processing module, wherein the power supply module provides power to the infrared detection module and the signal processing module.

Preferably, the infrared game control system of the present invention may further include a case, housing the infrared detection module, the signal processing module and the power supply module.

Preferably, the infrared game control system of the present invention may further include a camera device, capturing and recording an image, and housed in the signal processing module.

Preferably, the infrared game control system of the present invention may further include a mobile display device, displaying the image via Wi-Fi.

Preferably, the infrared game control system of the present invention is attached to a carrier. Moreover, the carrier may be a remote-controlled airplane, a remote-controlled boat or a remote-controlled vehicle.

Preferably, the infrared transmitter may be an infrared emitting component.

Preferably, the infrared receiver may be an infrared receiving component.

Preferably, the aim indicator LED and the hit indicator LED of the present invention may be green, white, blue, yellow, orange, purple, pink or red.

Preferably, the power supply module of the present invention may include a rechargeable battery, and the rechargeable battery is recharged by a carrier.

Preferably, the present invention may further include a plurality of static objects and a plurality of dynamic objects, having an infrared emitting device and an infrared receiving device. In addition, the infrared emitting device is an infrared emitting component and the infrared receiving device is an infrared receiving component.

According to the present invention, the present invention further provides an infrared game control method. The infrared game control method includes the steps of providing an infrared detection module having an infrared transmitter and an infrared receiver, wherein the infrared detection module transmits and receives an infrared signal; lighting up an aim indicator LED and a hit indicator LED of a signal processing module in accordance with the infrared signal received by the infrared receiver of the infrared detection module, wherein the signal processing module is electrically connected to the infrared detection module; providing a power supply module having an electrical switch, wherein the power supply module is electrically connected to the infrared detection module and the signal processing module, and provides power to the infrared detection module and the signal processing module; and determining a game mode, wherein the game mode is a mission mode, a chase mode, a specific action mode or a combination thereof.

Preferably, the infrared game control method may further include a step of providing a case, housing the infrared detection module, the signal processing module and the power supply module.

Preferably, the infrared game control method may further include a step of embedding a camera device, capturing and recording an image, and housed in the signal processing module.

Preferably, the infrared game control method of the present invention may further include a step of providing a mobile display device, displaying the image via Wi-Fi.

Preferably, the infrared game control method of the present invention may further include a step of providing a carrier, wherein the infrared game control system is attached to the carrier, and the carrier is a remote-controlled airplane, a remote-controlled boat or a remote-controlled vehicle.

Preferably, the infrared transmitter of the present invention may be an infrared emitting component.

Preferably, the infrared receiver of the present invention may be an infrared receiving component.

Preferably, the aim indicator LED and the hit indicator LED of the present invention may be green, white, blue, yellow, orange, purple, pink or red.

Preferably, the power supply module of the present invention may include a rechargeable battery, and the rechargeable battery is recharged by a carrier.

Preferably, the infrared game control method may further include a step of providing a plurality of static objects and a plurality of dynamic objects having an infrared emitting device and an infrared receiving device, wherein the infrared emitting device is an infrared emitting component and the infrared receiving device is an infrared receiving component.

As described above, the infrared game control system and the method thereof may bring about the following technical effects. In a game activity, the present invention not only includes the plurality of static objects and the plurality of dynamic objects but also constructs the plurality of game modes by using an infrared technology. Moreover, the present invention also has the advantage of high security, portability, low cost and availability to all ages.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a block diagram illustrating an infrared game control system according to the present invention;

FIG. 2 is a perspective view showing the infrared game control system according to the present invention; and

FIG. 3 is a flow chart showing an infrared game control method according to the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

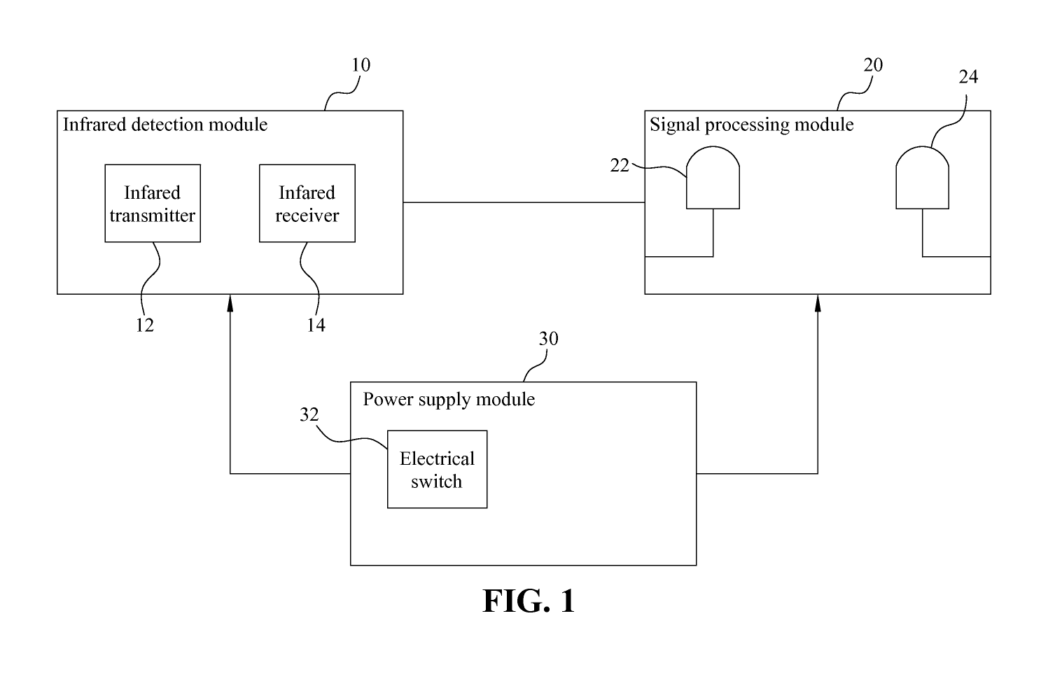

With regard to FIGS. 1-3, the drawings showing embodiments are semi-diagrammatic and not to scale and, particularly, some of the dimensions are for clarity of presentation and are shown exaggerated in the drawings. Similarly, although the views in the drawings for ease of description generally show similar orientations, this depiction in the drawings is arbitrary for the most part. Generally, the present invention can be operated in any orientation.

In light of the foregoing drawings, an objective of the present invention is to provide an infrared game control system. According to FIG. 1, the infrared game control system of the present invention includes an infrared detection module 10, having an infrared transmitter 12 and an infrared receiver 14, and transmitting and receiving an infrared signal; a signal processing module 20, having an aim indicator LED 22 and a hit indicator LED 24 and electrically connected to the infrared detection module 10, wherein the aim indicator LED 22 or the hit indicator LED 24 is lighted up in accordance with the infrared signal received by the infrared receiver 14 of the infrared detection module 10; and a power supply module 30, having an electrical switch 32 and electrically connected to the infrared detection module 10 and the signal processing module 20, wherein the power supply module 30 provides power to the infrared detection module 10 and the signal processing module 20, as shown in FIG. 1.

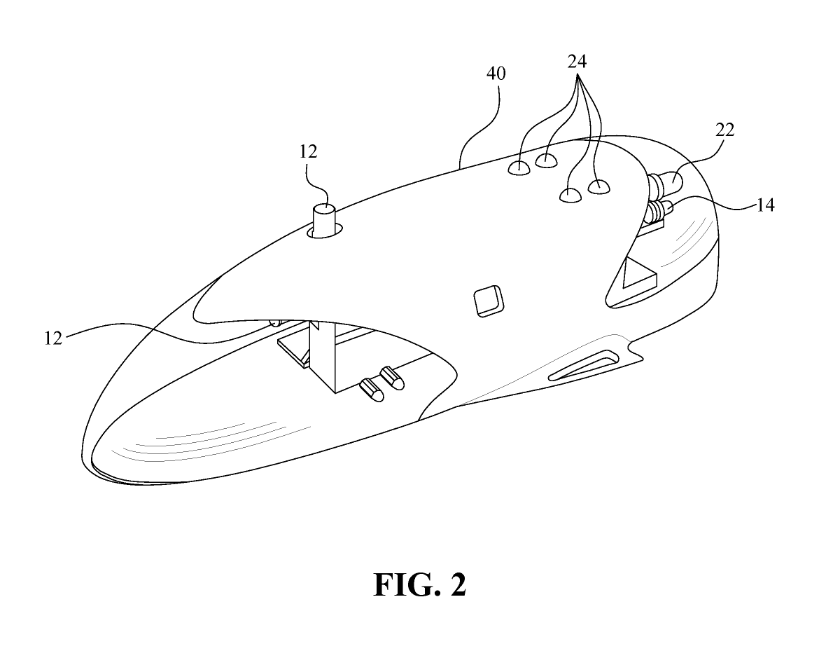

Referring to FIG. 2, the infrared game control system of the present invention may further include a case 40. The case 40 may house the infrared detection module 10, the signal processing module 20 and the power supply module 30.

Moreover, the infrared game control system of the present invention may further include a camera device (not shown). The camera device may capture and record an image.

In addition, according to the present invention, the infrared game control system may further include a mobile display device (not shown). The mobile display device may display the image via Wi-Fi.

Also, the infrared game control system of the present invention may be attached to a carrier. The carrier is a remote-controlled airplane, a remote-controlled boat or a remote-controlled vehicle.

According to the present invention, the infrared transmitter 12 may be an infrared emitting component.

In addition, the infrared receiver of the present invention may be an infrared receiving component.

According to the present invention, the aim indicator LED and the hit indicator LED may be green, white, blue, yellow, orange, purple, pink or red.

According to the present invention, the power supply module may include a rechargeable battery. The rechargeable battery may be charged by the carrier.

Further, the infrared game control system may further include a plurality of static objects and a plurality of dynamic objects (not shown) having an infrared emitting device and an infrared receiving device. The infrared emitting device may be an infrared emitting component and the infrared receiving device may be an infrared receiving component.

That is to say, in a game activity, a participant may turn on and control an unmanned vehicle having the infrared game control system of the present invention in a wireless manner. The unmanned vehicle may either be remote controlled or remote guided vehicle. For example, the unmanned vehicle may be an unmanned ground vehicle, an unmanned aerial vehicle or an unmanned surface vehicle.

An infrared signal may be transmitted from the infrared transmitter 12 of the infrared game control system to the plurality of static objects or the plurality of dynamic objects. When the infrared receiving device of a static object or a dynamic object receives the infrared signal, the aim indicator LED 22 is lighted up; that is, the static object or the dynamic object has been aimed. If the infrared receiving device of the static object or the dynamic object receives the infrared signal for 2 seconds, the infrared emitting device of the static object or the dynamic object may transmit a return infrared signal to the infrared receiver 14 of the infrared game control system. As such, when the infrared receiver 14 receives the return infrared signal, the hit indicator LED 24 is lighted up; that is, the static object or the dynamic object has been hit.

Additionally, according to the present invention, the plurality of static objects may be a U-shaped object, an O-shaped object, a column object, and so on. The plurality of static objects may be constructed by lightweight and sturdy frames, and coated with foam so as to reduce damage to the carrier due to a collision.

Moreover, the plurality of dynamic objects may be a remote-controlled airplane, a remote-controlled boat or a remote-controlled vehicle.

Referring to FIG. 2, FIG. 2 shows a perspective view of the infrared game control system according to the present invention.

According to the infrared game control system of the present invention, the infrared detection module 10, the signal processing module 20 and the power supply module 30 are housed in the case 40.

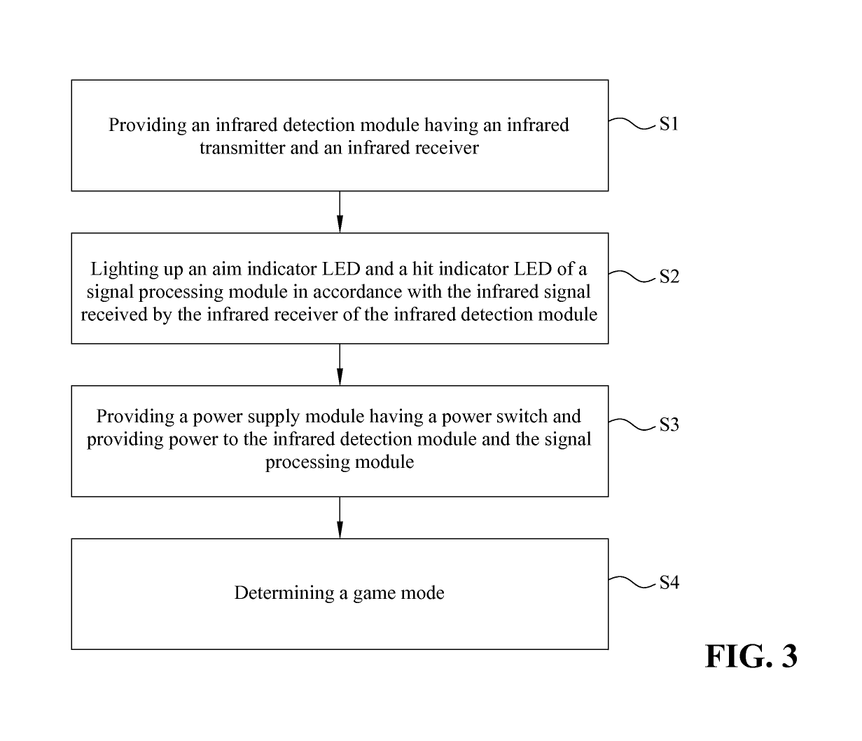

Referring to FIG. 3, the present invention further provides an infrared game control method, including the following steps.

Firstly, in step S1, an infrared detection module having an infrared transmitter and an infrared receiver is provided. The infrared detection module may transmit and receive an infrared signal. Then, proceed to step S2.

In step S2, an aim indicator LED and a hit indicator LED of a signal processing module may be lighted up in accordance with the infrared signal received by the infrared receiver of the infrared detection module. The signal processing module is electrically connected to the infrared detection module. Then, proceed to step S3.

In step S3, a power supply module having an electrical switch is provided. The power supply module is electrically connected to the infrared detection module and the signal processing module. As such, the power supply module may provide power to the infrared detection module and the signal processing module. Then, proceed to step S4.

According to the present invention, in step S4, a game mode may be determined. Additionally, the game mode may be a mission mode, a chase mode, a specific action mode or a combination thereof.

Moreover, the infrared game control method of the present invention may further include a step of providing a case. The infrared detection module, the signal processing module and the power supply module may be housed in the case.

In addition, the method of the present invention may further include a step of embedding a camera device. Therefore, an image may be captured and recorded by the camera device. The camera device may be housed in the signal processing module.

In the infrared game control method of the present invention, a step of providing a mobile display device may be further included. As such, the mobile display device may display the image via Wi-Fi.

According to the present invention, a step of providing a carrier may be further included. In other words, the infrared game control system of the present invention may be attached to the carrier. The carrier may be a remote-controlled airplane, a remote-controlled boat or a remote-controlled vehicle.

Moreover, according to the present invention, the infrared transmitter may be an infrared emitting component. The infrared receiver may be an infrared receiving component.

The aim indicator LED and the hit indicator LED of the present invention may be green, white, blue, yellow, orange, purple, pink or red.

According to the present invention, the power supply module may include a rechargeable battery. Also, the rechargeable battery may be recharged by the carrier.

Furthermore, the infrared game control method of the present invention may further include a step of providing a plurality of static objects and a plurality of dynamic objects (not shown) having an infrared emitting device and an infrared receiving device. The infrared emitting device may be an infrared emitting component, and the infrared receiving device may be an infrared receiving component.

In other words, when the infrared game control method of the present invention is performed, a participant may turn on and control an unmanned vehicle having the infrared game control system of the present invention in a wireless manner. The unmanned vehicle may either be remote controlled or remote guided vehicle. For example, the unmanned vehicle may be an unmanned ground vehicle, an unmanned aerial vehicle or an unmanned surface vehicle.

An infrared signal may be transmitted from the infrared transmit of the infrared game control system to the plurality of static objects or the plurality of dynamic objects. When the infrared receiving device of a static object or a dynamic object receives the infrared signal, the aim indicator LED is lighted up; that is, the static object or the dynamic object has been aimed. If the infrared receiving device of the static object or the dynamic object receives the infrared signal for seconds (such as 2 seconds), the infrared emitting device of the static object or the dynamic object may transmit a return infrared signal to the infrared receiver of the infrared game control system. Therefore, when the infrared receiver receives the return infrared signal, the hit indicator LED is lighted up; that is, the static object or the dynamic object has been hit.

According to the present invention, the plurality of static objects may be a U-shaped object, an O-shaped object, a column object, and so on. It should be noted that the plurality of static objects may be constructed by lightweight and sturdy frames, and coated with foam so as to reduce damage to the carrier due to a collision.

Additionally, the plurality of dynamic objects may be a remote-controlled airplane, a remote-controlled boat or a remote-controlled vehicle.

In a contest, the present invention may include a console, a media station, a player area and a scoreboard. The console may include a referee and a technician. The referee is responsible for presiding over the contest. The technician may provide technical support in the contest.

Moreover, the media station may display an image from a mobile display device to a big screen. The player area is an area that all the players may stay in, and will not be disturbed. Scores are displayed on the scoreboard.

According to the embodiment of the present invention, the infrared game control method of the present invention may include a number of different game modes such as a mission mode, a chase model and a specific action mode. These game modes are described as follows.

### Mission Mode

In a limited space, the infrared game control system of the present invention may be attached on a static carrier such a building. All the players must complete all the missions/tasks and hit all the static objects within a limited time (such as 5 minutes) without violating the rules of a game. When all the missions/tasks are completed by one of the players in a shortest time, the player may get the highest score (such as 10 points) in the game.

If all the missions/tasks cannot be completed by a player within the limited time, it means that the mission is failed. The player may only get 0.5 points, for example.

### Chase Mode

In a limited space, the infrared game control system of the present invention may be attached on a dynamic carrier such as unmanned vehicle. All the players must complete all the missions/tasks and hit all the dynamic objects within a limited time (such as 5 minutes) without violating the rules of a game. When all the missions/tasks are completed by one of the players in a shortest time, the player may get the highest score (such as 10 points) in the game.

In the chase mode, if all the missions/tasks cannot be completed by a player within the limited time, it means that the mission is failed. Therefore, the player may only get 0.5 points, for example.

### Specific Action Mode

In a limited space, a number of static objects or dynamic objects with different shapes are configured in a game. All the players must complete all the missions/tasks and hit all the number of static objects or dynamic objects within a limited time (such as 5 minutes) without violating the rules of a game. When all the missions/tasks are completed by each of players, the scores of players are listed in order.

However, in the specific action mode, if the player's carrier is damaged, the specific action mode is terminated. The player may only get 0.5 points, for example.

The above exemplary embodiment describes the principle and effect of the present invention, but is not limited to the present invention. It will be apparent to those skilled in the art that various modifications and variations can be made to the disclosed embodiments. It is intended that the specification and examples be considered as exemplary only, with a true scope of the disclosure being indicated by the following claims and their equivalents.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An infrared game control system, comprising:
an infrared detection module, having an infrared transmitter and an infrared receiver, and transmitting and receiving an infrared signal;
a signal processing module, having an aim indicator LED and a hit indicator LED and electrically connected to the infrared detection module, wherein the aim indicator LED or the hit indicator LED is lighted up in accordance with the infrared signal received by the infrared receiver of the infrared detection module; and
a power supply module, having an electrical switch and electrically connected to the infrared detection module and the signal processing module, wherein the power supply module provides power to the infrared detection module and the signal processing module.

2. The infrared game control system according to claim 1, further comprising a case, housing the infrared detection module, the signal processing module and the power supply module.

3. The infrared game control system according to claim 1, further comprising a camera device, capturing and recording an image, and housed in the signal processing module.

4. The infrared game control system according to claim 3, further comprising a mobile display device, displaying the image via Wi-Fi.

5. The infrared game control system according to claim 1, wherein the infrared game control system is attached to a carrier, wherein the carrier is a remote-controlled airplane, a remote-controlled boat or a remote-controlled vehicle.

6. The infrared game control system according to claim 1, wherein the infrared transmitter is an infrared emitting component.

7. The infrared game control system according to claim 1, wherein the infrared receiver is an infrared receiving component.

8. The infrared game control system according to claim 1, wherein the aim indicator LED and the hit indicator LED are green, white, blue, yellow, orange, purple, pink or red.

9. The infrared game control system according to claim 1, wherein the power supply module comprises a rechargeable battery, and the rechargeable battery is recharged by a carrier.

10. The infrared game control system according to claim 1, further comprising a plurality of static objects and a plurality of dynamic objects, having an infrared emitting device and an infrared receiving device, wherein the infrared emitting device is an infrared emitting component and the infrared receiving device is an infrared receiving component.

11. An infrared game control method, comprising the steps of:
providing an infrared detection module having an infrared transmitter and an infrared receiver, wherein the infrared detection module transmits and receives an infrared signal;
lighting up an aim indicator LED and a hit indicator LED of a signal processing module in accordance with the infrared signal received by the infrared receiver of the infrared detection module, wherein the signal processing module is electrically connected to the infrared detection module;
providing a power supply module having an electrical switch, wherein the power supply module is electrically connected to the infrared detection module and the signal processing module, and provides power to the infrared detection module and the signal processing module;
determining a game mode, wherein the game mode is a mission mode, a chase mode, a specific action mode or a combination thereof.

12. The infrared game control method according to claim 11, further comprising a step of providing a case, housing the infrared detection module, the signal processing module and the power supply module.

13. The infrared game control method according to claim 11, further comprising a step of embedding a camera device, capturing and recording an image, and housed in the signal processing module.

14. The infrared game control method according to claim 13, further comprising a step of providing a mobile display device, displaying the image via Wi-Fi.

15. The infrared game control method according to claim 11, further comprising a step of providing a carrier, wherein the infrared game control system is attached to the carrier, and the carrier is a remote-controlled airplane, a remote-controlled boat or a remote-controlled vehicle.

16. The infrared game control method according to claim 11, wherein the infrared transmitter is an infrared emitting component.

17. The infrared game control method according to claim 11, wherein the infrared receiver is an infrared receiving component.

18. The infrared game control method according to claim 11, wherein the aim indicator LED and the hit indicator LED are green, white, blue, yellow, orange, purple, pink or red.

19. The infrared game control method according to claim 11, wherein the power supply module comprises a rechargeable battery, and the rechargeable battery is recharged by a carrier.

20. The infrared game control method according to claim 11, further comprising a step of providing a plurality of static objects and a plurality of dynamic objects having an infrared emitting device and an infrared receiving device, wherein the infrared emitting device is an infrared emitting component and the infrared receiving device is an infrared receiving component.
